(19) United States
(12) Patent Application Publication
(10) Pub. No.: US 2012/0248861 A1
(43) Pub. Date: Oct. 4, 2012

(54) FLUID PRESSURE BOOSTER AND FLUID PRESSURE BRAKE APPARATUS HAVING THE SAME

(75) Inventors: Yoshihiro Miyata, Anjyo-shi (JP); Shigemitsu Nohira, Kariya-shi (JP)

(73) Assignee: ADVICS CO., LTD., Kariya-shi (JP)

(21) Appl. No.: 13/434,999

(22) Filed: Mar. 30, 2012

(30) Foreign Application Priority Data
Mar. 30, 2011 (JP) 2011-075574

(51) Int. Cl. B60T 13/128; B60T 13/16

(52) U.S. Cl. 303/10; 60/579

(57) ABSTRACT

A fluid pressure booster and a fluid pressure brake apparatus having the same are provided. The fluid pressure booster includes an auxiliary fluid pressure source having a pump and a pressure accumulator, a pressure adjusting device which adjusts fluid pressure supplied from the auxiliary fluid pressure source to a value corresponding to an operating amount of a brake operation member by displacement of a spool valve and introduces the same into a boost chamber, a boost piston which receives the fluid pressure introduced into the boost chamber to generate assist force and operates a master piston of a master cylinder by assisted force, and a displacement absorption member which is provided at a position to which thrust force of the master piston is applied, and which is compressed in an axial direction when transfer power between the boost piston and the master piston exceeds a setting value.

### CROSS REFERENCE TO RELATED APPLICATIONS

This application is based on and claims priority under 35 U.S.C.§119 to Japanese Patent Application 2011-075574, filed on Mar. 30, 2011, the entire content of which is incorporated herein by reference.

### BACKGROUND

1. Field of the Invention

The present invention relates to a fluid pressure booster which generates assist force corresponding to an operating amount of a brake operation member by using fluid pressure supplied from an auxiliary fluid pressure source and applies assisted force to a master cylinder, and a fluid pressure brake apparatus having the fluid pressure booster.

2. Description of Related Art

For example, U.S. Pat. No. 4,548,037 B discloses a basic technique of a fluid pressure booster which adjusts fluid pressure supplied from an auxiliary fluid pressure source having a power-operated pump and a pressure accumulator, to a value corresponding to an operating amount of a brake operation member with a pressure adjusting device having a spool valve, introduces the same into a boost chamber, applies the fluid pressure to a boost piston to generate assist force corresponding to the brake operating amount and applies assisted force (force obtained by adding the assist force to brake operating force applied by a vehicle driver) to a piston of a master cylinder.

Also, there has been known a fluid pressure brake apparatus having a reflux-type pressure adjusting unit which performs an ABS (antilock brake system) control or ESC (Electronic Stability Control) operation based on a command from an electronic control unit.

When the electronic control unit determines that it is necessary to decrease pressure of a wheel cylinder, based on information from a variety of sensors detecting wheel speed, operating stroke of a brake operation member, brake fluid pressure, movement of a vehicle and the like, the reflux-type pressure adjusting unit cuts off a fluid pressure path extending from the master cylinder to the wheel cylinder by a pressure increase solenoid valve and connects the wheel cylinder to a low pressure fluid storage by a pressure decrease solenoid valve, thereby performing pressure decrease control.

After that, when the electronic control unit determines that it is necessary to perform the pressurization again, the reflux-type pressure adjusting unit drives a power-operated reflex pump to pump up brake fluid in the low pressure fluid storage, opens the pressure increase solenoid valve and closes the pressure decrease solenoid valve, thereby refluxing the pumped brake fluid to the fluid pressure path extending from the master cylinder to the wheel cylinder.

Regarding the fluid pressure brake apparatus adopting the reflux-type pressure adjusting unit, two types are suggested. In one type device, a cutoff valve is provided at a more upstream side (master cylinder-side) than a position (reflux point) at which the brake fluid pumped by the reflux pump is introduced to the fluid pressure path extending from the master cylinder to the wheel cylinder, and the cutoff valve is closed when the control such as ABS is performed. In the other type device, the cutoff valve is not provided.

In the latter device having no cutoff valve, the brake fluid pumped by the reflux pump flows backward toward the master cylinder (hereinafter referred to as ‘pump back’).

According to the related-art fluid pressure brake apparatus having the reflux-type pressure adjusting unit, regarding a booster which is provided so as to assist a braking operation of a driver, a vacuum booster has been adopted which generates assist force by using a negative pressure of an engine. However, since it is not possible to expect the assist by the negative force of the engine in a valve matic vehicle in which an intake valve lift amount is continuously varied to enable an intake value to function as a throttle valve, an HEV (hybrid electric vehicle), an EV (Electric Vehicle) and the like. Therefore, it is considered to combine a fluid pressure booster. The fluid pressure booster applies fluid pressure (boost pressure) introduced into a boost chamber to a boost piston, thereby generating the assist force.

However, when the fluid pressure booster is adopted instead of the vacuum booster, the precision of the pressure adjustment is lowered due to the pump back, so that an operation feeling of the brake and the durability of a cup of the master cylinder are thus deteriorated. Therefore, measures capable of avoiding the problems are needed.

That is, when the pump back occurs, the piston of the master cylinder is pushed back by the fluid pressure flowing backward from the pressure adjusting unit. The pushing force is transferred to the boost piston (which is referred to as a power piston in the vacuum booster), so that the boost piston is also pushed back.

In the fluid pressure brake apparatus adopting the vacuum booster which operates a power piston by a pressure difference between a negative pressure chamber and an atmosphere chamber and thus generates the assist force, even when the power piston is pushed back, since the air sealed in the atmosphere chamber is compressed by displacement of the power piston, the pressure in the atmosphere chamber is not increased much and the influence of the pump back is suppressed to a slight amount.

Compared to the vacuum booster, according to the fluid pressure booster, brake fluid sealed in the boost chamber is compressed as the boost piston is pushed back due to the pump back, and the brake fluid is non-compressible oil. Therefore, the pressure increase in the boost chamber is not negligible until a discharge port, which enables the boost chamber to communicate with a reservoir, is opened.

For the fluid pressure brake apparatus in which electronic control of the wheel cylinder pressure is made by so-called differential pressure control, a pressure increase, which corresponds to the increase of the master cylinder pressure due to the pump back, occurs in the boost chamber, so that the master cylinder pressure is increased to balance with the boost pressure. Therefore, there would be caused the lowering of the control precision of the wheel cylinder pressure, which deteriorates the reliability of the ABS control and the like, the pulsation, which deteriorates the durability of the cup of the master cylinder and the like, the deterioration of the operation feeling of the brake and the like.

Also, in the fluid pressure brake apparatus in which the pressure adjusting control of the wheel cylinder by the electronic control is made by pulse control, when the boost pressure is increased by the pump back in a pressure boost mode, an introduction amount of the fluid pressure into the wheel cylinder is more increased than a target amount. Accordingly, there would be also caused the lowering of the control reliability, the deterioration of the operation feeling and the like although the degrees thereof are less than those in the fluid pressure brake apparatus adopting the differential pressure control.

### SUMMARY

Accordingly, an object of the present invention is to suppress the deterioration of the control precision of the wheel cylinder pressure, the pulsation influencing the durability of the cup of the master cylinder and the deterioration of the operation feeling of the brake, which are caused due to the pump back when the fluid pressure booster is used in combination with a reflux-type pressure adjusting unit (ABS unit or ESC unit).

According to an illustrative embodiment of the present invention, there is provided a fluid pressure booster for a fluid pressure brake apparatus, including: an auxiliary fluid pressure source including a power-operated pump and a pressure accumulator; a pressure adjusting device which adjusts fluid pressure supplied from the auxiliary fluid pressure source to a value corresponding to an operating amount of a brake operation member by displacement of a spool valve and introduces the adjusted fluid pressure into a boost chamber; a boost piston which receives the fluid pressure introduced into the boost chamber to generate assist force and operates a master piston of a master cylinder by assisted force; and a displacement absorption member which is provided at a position to which thrust force of the master piston is applied, and which is compressed in an axial direction when transfer power between the boost piston and the master piston exceeds a setting value.

The above fluid pressure booster may include a maximum reaction force regulation mechanism which allows the axial compression of the displacement absorption member when the fluid pressure of the boost chamber is lower than the fluid pressure of the auxiliary fluid pressure source and regulates an increase in an amount of the axial compression of the displacement absorption member when the fluid pressure of the boost chamber is equal to or higher than the fluid pressure of the auxiliary fluid pressure source.

According to another illustrative embodiment of the present invention, there is provided a fluid pressure brake apparatus including: the above fluid pressure booster; a brake operation member which applies brake operating force to the fluid pressure booster; a master cylinder having a master piston which is operated while being assisted by the fluid pressure booster; a wheel cylinder which generates braking force by fluid pressure supplied from the master cylinder; a reflux-type pressure adjusting unit including a pressure decrease solenoid valve which enables the fluid pressure of the wheel cylinder to flow out, a pressure increase solenoid valve which introduces the fluid pressure into the wheel cylinder, and a reflux pump which pumps up brake fluid having flown out from the wheel cylinder via the pressure decrease solenoid valve and thus refluxes the same to a fluid pressure path extending from the master cylinder to the wheel cylinder; and an electronic control unit which determines whether it is necessary to decrease pressure of the wheel cylinder and whether it is necessary to re-pressurize the wheel cylinder and outputs an operating command to the pressure decrease solenoid valve and the pressure increase solenoid valve.

In the above fluid pressure brake apparatus, the displacement absorption member may be formed by an elastic member which can be compressed in an axial direction of the boost piston.

In the above fluid pressure brake apparatus, the master piston may be formed with a guide hole which is opened at an end face of a side facing the boost piston, a plunger which receives driving force from the boost piston via a power transmission member may be inserted into the guide hole to be slidable in the axial direction, and the displacement absorption member may be interposed between the plunger and a wall surface of an inner end of the guide hole.

In the above fluid pressure brake apparatus, initial load of the elastic member may have a magnitude, with which the elastic member is not compression-deformed when the master cylinder pressure is equal to or lower than a lowest operating pressure of the reflux-type pressure adjusting unit (lowest operating pressure in ABS control at a low μ road).

In the fluid pressure brake apparatus, the displacement absorption member may be interposed on a power transmission path between the boost piston and the master piston.

In the above fluid pressure brake apparatus, a reaction force provision member which generates reaction force corresponding to an operating amount of the brake operation member and applies the same to the brake operation member and has a jumping characteristic may be interposed on a power transmission path between the boost piston and the master piston, and the displacement absorption member may be formed by an elastic member having initial load larger than reaction force of a brake operation which is obtained at a position at which a rapid increase in the master cylinder pressure due to the jumping characteristic ends.

According to the fluid pressure booster and the fluid pressure brake apparatus having the same, when the master piston of the master cylinder is applied with the pushing back force due to the pump back, the displacement absorption member is compressed. Hence, the piston displacement which is transferred from the master piston to the boost piston or the amount that the master piston itself is pushed back is decreased and the amount that the boost piston is pushed back by the master piston is also decreased, so that the increase of the boost pressure and the resultant increase of the master cylinder pressure are suppressed. As a result, the control precision of the wheel cylinder pressure is stabilized and the reliability of the ABS control or ESC control is improved.

Also, the increase of the boost pressure is suppressed, and therefore, the generation of the pulsation is suppressed and the deterioration of the operation feeling of the brake is also suppressed.

In the meantime, the displacement absorption member is formed by the elastic member which can be compressed in the axial direction of the boost piston. Thus, when the initial load of the elastic member is appropriately set, it is possible to avoid that the displacement absorption member is compressed when the master cylinder pressure is equal to or lower than the lowest operating pressure of the reflux-type pressure adjusting device and that the corresponding influence is exerted on the normal braking.

Also, even when the displacement absorption member is interposed on the power transmission path between the boost piston and the master piston, there is no concern that the displacement absorption member has an influence on responsiveness of the master cylinder.

Furthermore, the master piston is formed with the guide hole, the plunger that receives the driving force from the boost piston via the power transmission member is inserted into the guide hole and the displacement absorption member is interposed between the plunger and the wall surface of the inner end of the guide hole. Thereby, it is possible to bring the power transmission member into contact with the plunger so that it can be displaced in a radial direction and to provide the contact part with a function of absorbing a deviation of shaft centers of the master piston and the boost piston.

In addition, the reaction force provision member having the above-described jumping characteristic is interposed on the power transmission path between the boost piston and the master piston and the displacement absorption member is formed by the elastic member having the initial load larger than the reaction force of the brake operation which is obtained at a position at which the master cylinder pressure starts to increase in proportion to the brake operating amount. Thereby, the ending time of the jumping pressure boost is not moved up by the displacement absorption member. Accordingly, the jumping characteristic and the operation feeling of the brake are not changed.

### BRIEF DESCRIPTION OF THE DRAWINGS

The foregoing and additional features and characteristics of this disclosure will become more apparent from the following detailed description considered with the reference to the accompanying drawing, wherein:

FIG. 1 is a sectional view showing an outline of a fluid pressure booster and a fluid pressure brake apparatus according to a first illustrative embodiment of the present invention.

### DETAILED DESCRIPTION

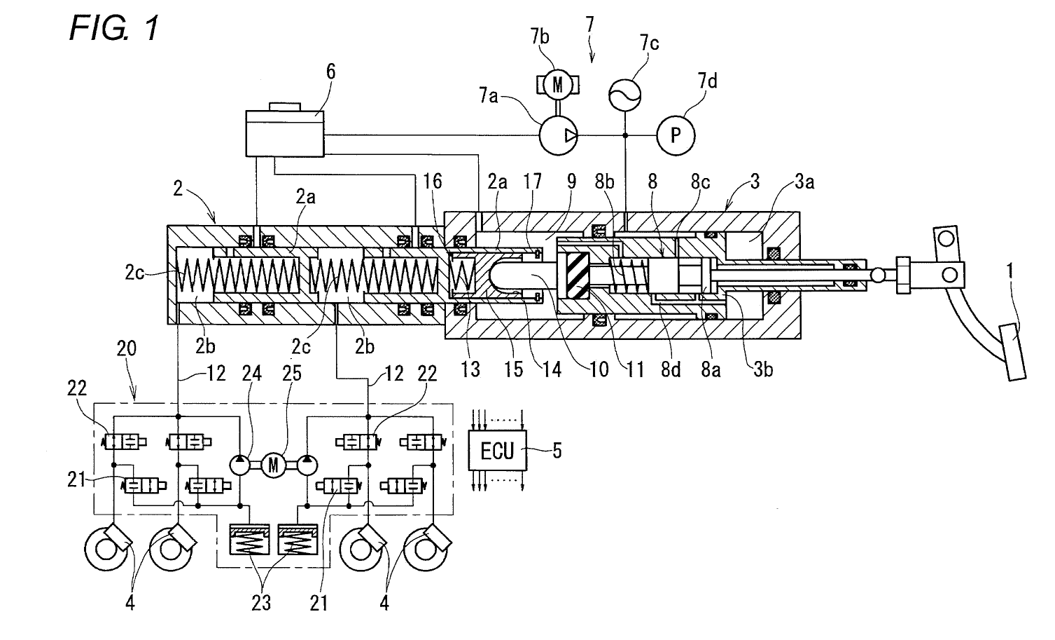

Hereinafter, an illustrative embodiment of a fluid pressure booster and a fluid pressure brake apparatus having the same is described with reference to FIG. 1.

A fluid pressure brake apparatus shown in FIG. 1 includes a brake operation member (brake pedal in FIG. 1) 1, a master cylinder 2, a fluid pressure booster 3, a wheel cylinder 4 which generates braking force by fluid pressure supplied from the master cylinder 2, a reflux-type pressure adjusting unit 20 and an electronic control unit 5. A reference numeral 6 indicates a reservoir which is provided as an auxiliary fluid source. A sensor or the like which transmits information, which indicates necessity of pressure decrease and pressure increase of the wheel cylinder 4, to the electronic control unit 5 is not shown in the FIGURE.

As an example of the master cylinder 2, a known tandem type master cylinder is shown which includes a return spring 2c pressing a master piston 2a to generate fluid pressure in a pressure chamber 2b.

The fluid pressure booster 3 has an auxiliary fluid pressure source 7 and a pressure adjusting device 8 which adjusts the fluid pressure supplied from the auxiliary fluid pressure source 7, to a value corresponding to an operating amount of the brake operation member 1 and introduces the same into a boost chamber 3a.

The fluid pressure booster 3 has a boost piston 3b which receives the fluid pressure (boost pressure) introduced into the boost chamber 3a to generate assist force and operate the master piston 2a of the master cylinder 2 by assisted force (thrust force, obtained by adding the assist force to brake operating force applied by a vehicle driver), and a displacement absorption member 13.

The auxiliary fluid pressure source 7 includes a pump 7a, a motor 7b driving the pump 7a, a pressure accumulator (accumulator) 7c and a pressure sensor 7d. The motor 7b is on/off based on pressure detected by the pressure sensor 7d, thereby maintaining the fluid pressure accumulated in the pressure accumulator 7c within a range of predetermined upper and lower limits.

The pressure adjusting device 8 has a spool valve 8a which receives operating force input from the brake operation member 1 and is thus displaced and a return spring 8b of the spool valve 8a. Also, the pressure adjusting device 8 has an introduction passage 8c and an exhaust passage 8d which are formed in the boost piston 3b.

The introduction passage 8c and the exhaust passage 8d are opened by displacement of the spool valve 8a. When the introduction passage 8c is opened, the boost chamber 3a is connected to the auxiliary fluid pressure source 7, and when the exhaust passage 8d is opened, the boost chamber 3a is connected to the reservoir 6 via a fluid chamber 9.

The pressure adjusting device 8 enables the boost chamber 3a to connect the auxiliary fluid pressure source 7 or the reservoir 6 and to disconnect from both the auxiliary fluid pressure source 7 and the reservoir 6, depending on the displacement of the spool valve 8a. By the operation of the pressure adjusting device 8, the fluid pressure (boost pressure) which is introduced from the auxiliary fluid pressure source 7 to the boost chamber 3a is adjusted to a value corresponding to an operating amount of the brake operation member. Since the pressure adjusting mechanism is known, the detailed description thereof is omitted.

The boost piston 3b is moved forward by the boost pressure of the boost chamber 3a and the thrust force (assisted force) is transferred to the master cylinder 2 via a power transmission member 10, so that the master piston 2a is operated and brake fluid pressure is generated in the pressure chamber 2b. In the tandem master cylinder, when the right master cylinder 2a of FIG. 1 is operated and the fluid pressure is thus generated in the right pressure chamber 2b, the left master cylinder 2a is also operated by the fluid pressure and the fluid pressure of the same pressure as the right is also generated in the left pressure chamber 2b.

The pressure generated in the respective pressure chambers 2b of the master cylinder has a value which balances with the boost pressure of the boost chamber 3a. Reaction force of the pressure generated in the pressure chambers 2b is transferred from the master piston 2a to the brake operation member 1 through the displacement absorption member 13, the power transmission member 10, a reaction force provision member 11 and the spool valve 8a.

The reaction force provision member 11 is a known member made of a rubber disk and generates reaction force in correspondence to the brake operating amount. The reaction force provision member 11 has a jumping characteristic which makes an increase amount of the master cylinder pressure per unit brake operating force (unit stepping force) at the early stage of the operation of the brake operation member 1 larger than that at the later stage of the operation. The reaction force provision member 11 is adapted to provide the reaction force corresponding to the brake operation to the brake operation member 1 such that the increase amount of the master cylinder pressure per unit brake operating amount is decreased from a position at which the jumping pressure increase ends. The reaction force provision member 11 is a preferable element but is not necessarily required.

It is shown that the displacement absorption member 13 is made of a coil spring. However, the displacement absorption member 13 may be also made of a disc spring, a rubber piece or the like.

The coil spring which is provided as the displacement absorption member 13 has initial load larger than the reaction force of the brake operation which is obtained at the position at which the jumping pressure increase ends. Hence, the ending time of the jumping pressure increase (time at which the master cylinder pressure per unit brake operating force is changed) is not varied by the displacement absorption member. Accordingly, the jumping characteristic and the operation feeling of the brake are not changed.

In the brake device, the master piston 2a is formed with a guide hole 14 which is opened at an end face of a side facing the boost piston 3b, a plunger 15 is inserted into the guide hole 14 to be slidable in an axial direction, and the displacement absorption member 13 is interposed between the plunger 15 and a wall surface of an inner end of the guide hole 14. The power transmission member 10 is brought into contact with the plunger 15, so that the driving force from the boost piston 3b is transferred to the master piston 2a via the displacement absorption member 13.

According to the above structure, when positions of the boost piston 3b and the master piston 2a are deviated in a radial direction, a difference of the positions is absorbed at the contact part of the power transmission member 10 with the plunger 15. Therefore, even when the positions of the boost piston 3b and the master piston 2a are deviated in a radial direction, there is no worry that the plunger 15 is distorted and is thus difficult to slide.

In the meantime, a bottom (inner end) of the guide hole 14 and a left end of the plunger 15 configure a maximum reaction force regulation mechanism 16, and the compression of the displacement absorption member 13 is regulated at a position at which the plunger 15 contacts the bottom of the guide hole 14.

The initial load of the coil spring which is provided as the displacement absorption member 13 is load at a position at which the plunger 15 contacts a stopper 17. The initial load is made to be larger than the reaction force of the brake operation which is obtained at a position at which the rapid increase of the master cylinder pressure influencing the jumping characteristic ends. Thereby, it is possible to prevent the deterioration of the durability, which is caused due to the unnecessary compression of the displacement absorption member 13.

Also, the maximum reaction force regulation mechanism 16 is provided, so that when the rapid increase of the brake force takes priority over the prevention of the deterioration of the operation feeling of the brake due to the pump back at the time of the rapid brake operation, it is possible to prevent the lowering of the increase rate of the brake force due to the compression of the displacement absorption member 13.

In the meantime, the displacement absorption member 13 may be provided to a tip end of the master cylinder 2 (a left end of the left pressure chamber 2b in FIG. 1). Also, for a tandem master cylinder having two master pistons, the displacement absorption member 13 may be provided between the two master pistons.

When the displacement absorption member 13 is provided to the tip end of the master cylinder 2, the guide hole may be formed in a housing of the master cylinder, the plunger may be inserted into the guide hole, the displacement absorption member 13 may be arranged between the plunger and the inner end of the guide hole, and the left return spring 2c in FIG. 1 may be supported with the plunger.

Also, when the displacement absorption member 13 is provided between the master pistons of the master cylinder, the guide hole may be formed in the left master cylinder in FIG. 1 which receives the fluid pressure of the one pressure chamber and is thus operated, the plunger may be inserted into the guide hole, the displacement absorption member 13 may be arranged between the plunger and the inner end of the guide hole, and the right return spring 2c in FIG. 1 may be supported with the plunger.

The reflux-type pressure adjusting unit 20 is a known unit including a pressure decrease solenoid valve 21 which enables the fluid pressure of the wheel cylinder 4 to flow out, a pressure increase solenoid valve 22 which introduces the fluid pressure into the wheel cylinder 4, a low pressure fluid storage 23 which temporarily receives the brake fluid having flown out from the wheel cylinder 4 via the pressure decrease solenoid valve 21, a reflux pump 24 which pumps up the brake fluid having flown out from the wheel cylinder 4 and thus refluxes the same to a fluid pressure path 12 extending from the master cylinder 2 to the wheel cylinder 4 and a motor 25 that drives the reflux pump 24.

The pressure decrease solenoid valve 21 and the pressure increase solenoid valve 22, which configure the reflux-type pressure adjusting unit 20, may be on/off type solenoid valves or known linear solenoid valves in which a degree of opening of a valve part is adjusted depending on an amount of current to be supplied to a coil.

According to the fluid pressure brake apparatus of FIG. 1 configured as described above, when the reflux-type pump 24 is driven in response to a command from the electronic control unit 5 during the braking, the pump back occurs and the master piston 2a of the master cylinder is pushed back. At this time (when the reflux-type pump 34 is driven), the boost chamber 3a is separated and sealed from the reservoir 6 and the auxiliary fluid pressure source 7. However, when the master piston 2a is pushed back, the displacement absorption member 13 is compressed in an axial direction. Thereby, the master piston 2a and the boost piston 3b relatively come close to each other, and an amount which the boost piston 3b is pushed back becomes smaller than an amount which the master piston 2a is pushed back. Therefore, the increase in pressure of the boost chamber is suppressed and thus the increase in pressure of the master cylinder is also suppressed, so that the control precision of the wheel cylinder pressure is stabilized. As a result, the reliability of the ABS control or ESC control is improved.

Also, the increase of the boost pressure is suppressed, so that the deterioration of the operation feeling of the brake and the occurrence of the pulsation influencing the durability of the cup of the master cylinder are also suppressed.

Meanwhile, in FIG. 1, the displacement absorption member 13 is arranged at a position to which the rearward thrust force of the master piston 2a is applied. However, even when the displacement absorption member 13 is arranged at a position to which the forward thrust force of the master piston 2a is applied, i.e., in the pressure chamber arranged at the leading end of the master cylinder or in the pressure chamber arranged between the two master pistons, the displacement absorption member 13 is compressed at the time of occurrence of the pump back and thus the amount that the master piston itself is pushed back is decreased. Therefore, the increase of the boost pressure due to the decrease of the pushed-back amount that the boost piston and the resultant increase of the master cylinder pressure are suppressed.

What is claimed is:

1. A fluid pressure booster for a fluid pressure brake apparatus, comprising:
an auxiliary fluid pressure source including a power-operated pump and a pressure accumulator;
a pressure adjusting device which adjusts fluid pressure supplied from the auxiliary fluid pressure source to a value corresponding to an operating amount of a brake operation member by displacement of a spool valve and introduces the adjusted fluid pressure into a boost chamber;
a boost piston which receives the fluid pressure introduced into the boost chamber to generate assist force and operates a master piston of a master cylinder by assisted force; and
a displacement absorption member which is provided at a position to which thrust force of the master piston is applied, and which is compressed in an axial direction when transfer power between the boost piston and the master piston exceeds a setting value.

2. The fluid pressure booster according to claim 1, further comprising:
a maximum reaction force regulation mechanism which allows the axial compression of the displacement absorption member when the fluid pressure of the boost chamber is lower than the fluid pressure of the auxiliary fluid pressure source and regulates an increase in an amount of the axial compression of the displacement absorption member when the fluid pressure of the boost chamber is equal to or higher than the fluid pressure of the auxiliary fluid pressure source.

3. A fluid pressure brake apparatus comprising:
the fluid pressure booster according to claim 1;
a brake operation member which applies brake operating force to the fluid pressure booster;
a master cylinder having a master piston which is operated while being assisted by the fluid pressure booster;
a wheel cylinder which generates braking force by fluid pressure supplied from the master cylinder;
a reflux-type pressure adjusting unit including a pressure decrease solenoid valve which enables the fluid pressure of the wheel cylinder to flow out, a pressure increase solenoid valve which introduces the fluid pressure into the wheel cylinder, and a reflux pump which pumps up brake fluid having flown out from the wheel cylinder via the pressure decrease solenoid valve and thus refluxes the same to a fluid pressure path extending from the master cylinder to the wheel cylinder; and
an electronic control unit which determines whether it is necessary to decrease pressure of the wheel cylinder and whether it is necessary to re-pressurize the wheel cylinder and outputs an operating command to the pressure decrease solenoid valve and the pressure increase solenoid valve.

4. The fluid pressure brake apparatus according to claim 3,
wherein the displacement absorption member is formed by an elastic member which can be compressed in an axial direction of the boost piston.

5. The fluid pressure brake apparatus according to claim 4,
wherein initial load of the elastic member has a magnitude, with which the elastic member is not compression-deformed when the master cylinder pressure is equal to or lower than a lowest operating pressure of the reflux-type pressure adjusting unit.

6. The fluid pressure brake apparatus according to claim 3,
wherein the displacement absorption member is interposed on a power transmission path between the boost piston and the master piston.

7. The fluid pressure brake apparatus according to claim 6,
wherein the master piston is formed with a guide hole which is opened at an end face of a side facing the boost piston,
wherein a plunger which receives driving force from the boost piston via a power transmission member is inserted into the guide hole to be slidable in the axial direction, and
wherein the displacement absorption member is interposed between the plunger and a wall surface of an inner end of the guide hole.

8. The fluid pressure brake apparatus according to claim 3,
wherein a reaction force provision member which generates reaction force corresponding to an operating amount of the brake operation member and applies the same to the brake operation member and has a jumping characteristic is interposed on a power transmission path between the boost piston and the master piston, and
wherein the displacement absorption member is formed by an elastic member having initial load larger than reaction force of a brake operation which is obtained at a position at which a rapid increase in the master cylinder pressure due to the jumping characteristic ends.
